(19) United States
(12) Patent Application Publication
(10) Pub. No.: US 2003/0187833 A1
(43) Pub. Date: Oct. 2, 2003

(54) Hypermedia resource search engine and related indexing method

(76) Inventor: Michel Plu, Lannion (FR)

Correspondence Address: YOUNG & THOMPSON, 745 SOUTH 23RD STREET 2ND FLOOR, ARLINGTON, VA, 22202

(21) Appl. No.: 10/240,720

(22) PCT Filed: Apr. 3, 2001
(86) PCT No.: PCT/FR01/00998

(30) Foreign Application Priority Data
Apr. 6, 2000 (FR) 00/04419

(51) Int. Cl. G06F 17/30

(52) U.S. Cl. 707/3

(57) ABSTRACT

The invention provides a search engine comprising firstly an indexing module for indexing resources accessible on a computer network to create and update and indexing database, and secondly a search module for searching resources on the network and adapted to interrogate the indexing database on the basis of a request formulated by a user and to respond by supplying the URLs of resources corresponding to the request, the indexing module having means for collecting main resources, means for extracting dependent resources from the main resources, and means for indexing resources to extract descriptors therefrom. In addition, the indexing module further comprises association means for associating each dependent resource with no more than one main resource as a function of hypertext type links between the dependent resources and the main resource.

The present invention relates to a search engine comprising firstly an indexing module for indexing resources accessible on a computer network to create and update and indexing database, and secondly a search module for searching the network for resources and adapted to interrogate the indexing database on the basis of a request formulated by a user and to respond by supplying the uniform resource locators (URLs) of resources corresponding to the request, the indexing module having means for collecting main resources, means for extracting dependent resources from the main resources, and means for indexing resources to extract descriptors therefrom.

Such search engines now exist. Amongst these search engines, full page search engines operate as follows:

starting from an initial list of URLs, e.g. addresses that are defined manually, the indexing module automatically collects the resources that are accessible at said addresses;

from each of these resources, the indexing means extract an index associating it with a set of words characterizing its content; and

the extraction means extract from each previously indexed resource the set of URLs of the hypertext links it contains, thus enabling new URL addresses to be added to the initial list.

The process can thus be reiterated in order to end up with a very large number of indexed resources.

In addition, that loop is executed periodically in order to update the indexing database as a function both of the way the content of the resources of the initial list varies, and also of new links appearing.

In response to a request formulated by a user, the search engine sends the URLs of the resources that correspond to the request, ordering them using a system of counting words in the indexing database. As a general rule, this gives rise to thousands of responses for one request. Furthermore, the order in which these responses are presented does not always solve the problem of searching through these too-numerous resources. This order does not correspond to the needs of the user such as the usage of the searched resources, the desired quality of its information, or any other personal criterion of the user.

Another problem associated with that type of search engine is that the responses supplied give direct access to the content of the resources whose assessment by the user sometimes depends on the user having previously read other resources.

The invention seeks to remedy the drawbacks of conventional search engines by creating a search engine giving access to numerous resources while improving the quality of the responses supplied, particularly as a function of the user's needs.

The invention thus provides a search engine of the above-specified type, characterized in that the indexing module further comprises association means for associating each dependent resource with no more than one main resource as a function of hypertext type links between the dependent resources and the main resource.

As a result, the main resources of a first information base are collected and indexed. This is combined with a large number of resources identified from the hypertext links present in the main resources.

The search engine of the invention may further comprise one or more of the following characteristics:

the indexing module has means for transferring a copy of the descriptors of the main resources to the dependent resources associated therewith;

the search module has means for filtering a resource indexed by the indexing module by combined processing of descriptors extracted from said resource and of descriptors transferred to said resource;

the search module is adapted to respond to a requests by supplying the URL of a dependent resource corresponding to the requests, associated with the hypertext link of the main resource associated with said dependent resource;

the association means include means for selecting not more than one main resource from a set of main resources that might be associated with a dependent resource by minimizing a distance computed between the dependent resource and each main resource; and

the distance between two resources is a decreasing function of the number of folders in common between the URLs of the two resources.

The invention also provides a method of indexing resources accessible on a computer network so as to create and update an indexing database, the method comprising the following steps:

collecting main resources;

indexing the main resources; and

extracting dependent resources from the main resources;

the method being characterized in that it further comprises the following:

associating each dependent resource with not more than one main resource as a function of the hypertext links between these dependent resources and the main resource; and

transferring a copy of the descriptors of the main resources to the dependent resources that are associated therewith.

The indexing method of the invention may also comprises a step of excluding from the indexing database any dependent resource not associated with a main resource.

The invention will be better understood from the following description given purely by way of example and made with reference to the accompanying drawings, in which:

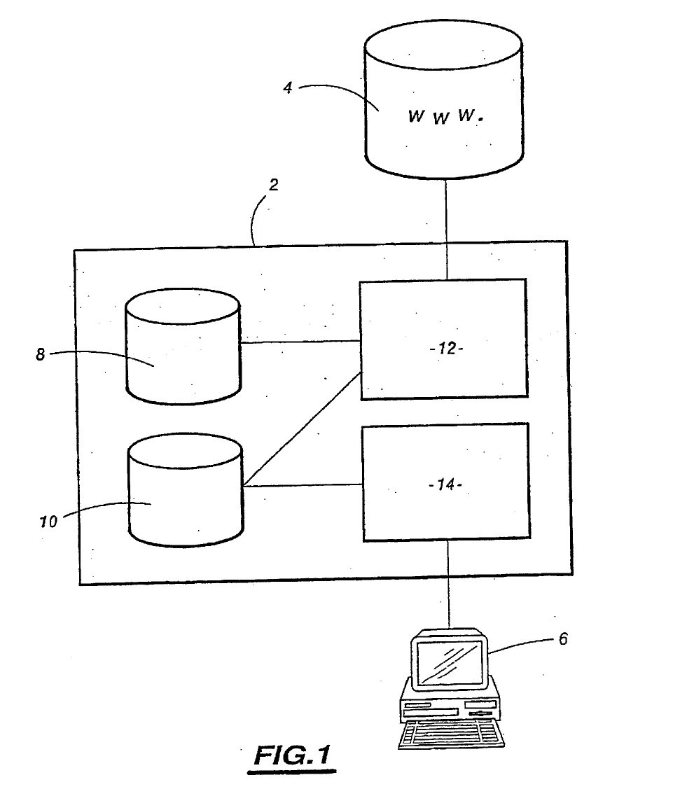

FIG. 1 is a diagram showing the general structure of a search engine of the invention;

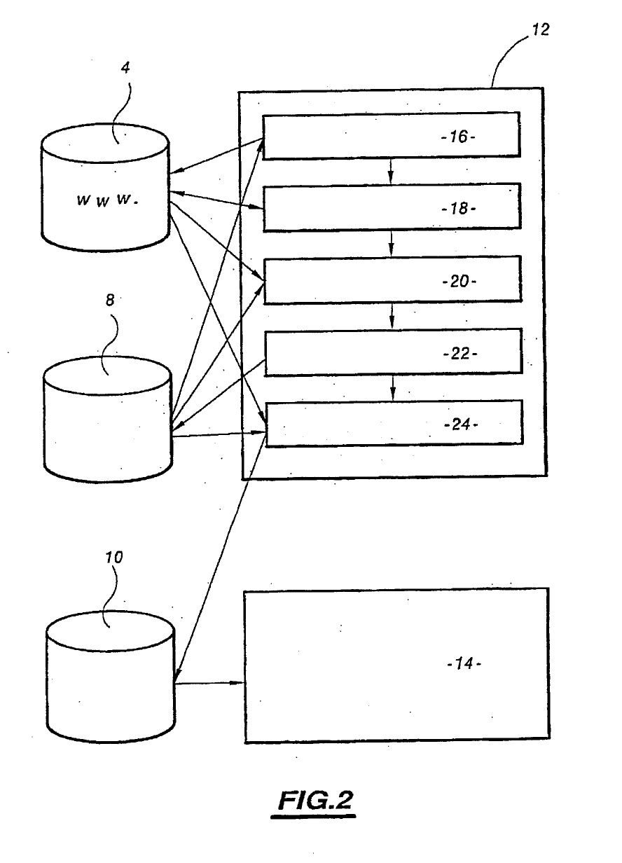

FIG. 2 is a diagram showing the operation of a search engine of the invention; and

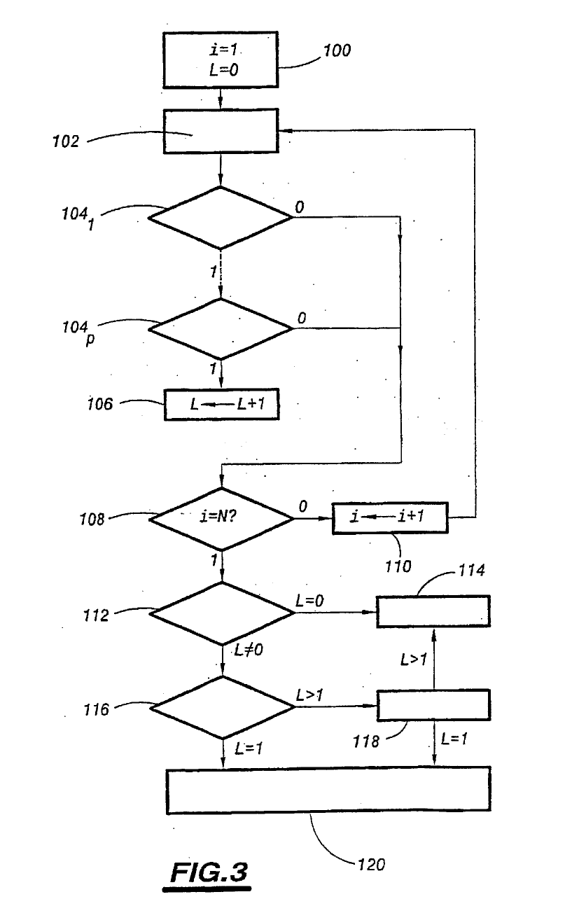

FIG. 3 is a flow chart showing details of the operation of the means for associating a dependent resource with at most one main resource in a search engine of the invention.

A search engine of the invention shown in FIG. 1 comprises a server 2 connected via the Internet firstly to a database 4 constituted by the World Wide Web, and secondly to an access terminal 6 of a user seeking resources that are available on the Web.

The server 2 has a database 8 of directories. A directory comprises a restricted set of URLs of main resources, each corresponding to the first page of a multimedia document. These main resources are associated with external descriptors, e.g. recorded manually by research assistants, optionally assisted by computer tools. These external descriptors correspond to classification in a list of subjects, to a title, to a textual description of a main resource, and in more general manner to information specifying the context of the documents under consideration.

The server 2 also has an indexing database 10 comprising all of the resource descriptors accessible by the search engine. In particular, it comprises the external descriptors of the main resources, as described above.

The server 2 also has an indexing module 12 comprising means for automatically indexing resources. These means are capable of extracting external descriptors by analyzing resource content in conventional manner. This module also includes a method of associating dependent resources with a main resource and of transferring external descriptors of a main resource to its dependent resources. The operation of this module is described in detail below, with reference to FIG. 2.

The indexing module thus has inputs connected to the directory database 8 and to the Web 4, so as to access resources, and has an output connected to the indexing database 10 in order to supply descriptors.

Finally, the server 2 has a search module 14 connected firstly to the indexing database 10 and secondly to the access terminal 6 in order to supply a user with pertinent resources in response to a request from the user.

The operation of the search engine having the structure as described above is shown in FIG. 2.

The indexing module 12 proceeds with recording descriptors in the indexing database 10 in several steps.

During a first step 16 of collection, the indexing module 12 accesses the main resources accessible on the Web 4, and receives as inputs their URLs which are stored in the directory database 8.

During a second step 18 of extraction, extraction means extract from each main resource all of the URLs of the hypertext links that it contains. Dependent, new resources are thus recovered from which it is possible again to extract the URLs of the hypertext links they themselves contain. This recursive method of extracting dependent resources from a first set of main resources is known in the state of the art. The first set, conventionally referred to as the “seed” is in this case extracted from the directory database 8.

During a third step 20 of association, extractor means associate each dependent resource with at most one main resource. This association is a function of the number, the type, or any other attribute of the hypertext link that must be followed to reach the dependent resource from the URLs of the main resource. At the end of this step, dependent resources not associated with a main resource are eliminated. This method is described in detail below with reference to FIG. 3.

During a fourth step 22 of transfer, transfer means copy the external descriptors of each main resource and transfer them to all of the dependent resources associated therewith.

Finally, during a fifth step 24 of indexing, the indexing means extract descriptors in automatic manner for each resource. During this step, the indexing module 12 records the descriptors relating to each resource in the indexing database 10, said descriptors comprising both the descriptors that have been extracted automatically and the external descriptors transferred by copying to a dependent resource from the main resource associated with said dependent resource, or extracted directly from the directory database 8 for a main resource.

The method described above, from the first step to the fifth step, is reiterated regularly in order to keep the indexing database up to date as a function of changes in the main resources of the directory database, and also as a function of changes in the hypertext links they contain.

When the indexing database is up to date, the user accesses a request form defined by the search module 14. This request forms takes the form of a page in hypertext mark-up language (HTML) format. It enables the user to input at least a key word and to specify the context of the search by selecting values for various descriptors in a proposed list. The descriptors in the proposed list correspond to at least some of the external descriptors stored in the directory database 8 and describing the main resources. For example they make it possible to refine the search domain, the user's age range, etc. This additional information enables the search module to filter the resources corresponding to the key words of the request.

The responses are thus constituted by main resources and by dependent resources having extracted descriptors that correspond to the key words, and having external descriptor values corresponding to those selected by the user.

Amongst these responses, each dependent resource returned by the search engine to the user is accompanied by a hypertext link to the main resource associated with said dependent resource.

The method of associating a dependent resource to no more than one main resource from a set of N main resources complies with the flow chart shown in FIG. 3.

An initialization step 100 initializes an index i to 1 and a counter L to zero.

Thereafter, an analysis step 102 identifies a path, i.e. a sequence of hypertext links that needs to be followed in order to reach the dependent resource from the URLs of the i-th main resource.

Thereafter, in a series of 2 steps 104₁, . . . , 104ₚ, a set of rules is established relating to the paths identified in step 102, and more particularly to the number of links, their type, and their attributes.

In conventional manner, seven types of link are defined:

presentation structure links, such as frames, tables, or included elements;

cross links between two files in the same folder;

parallel links for files situated in different folders, themselves situated in the same folder;

external links between files situated in different sites;

deeper links when the file of the dependent resource is situated in a subfolder of the folder of the file of the main resource;

higher links when the file of the main resource is situated in a subfolder of the folder of the file of the dependent resource; and

menu links for links included in a resource for which the number of included links divided by the size of the resource measured in bytes is greater than a predetermined threshold.

Attributes are associated in conventional manner with link anchors and are known in the state of the art.

If at least one of the rules is not satisfied, then the method is taken to a step 108. If all of the rules are satisfied, when the i-th main resource is temporarily associated with the dependent resource and the method is taken to a step 106. By way of example, a rule can be “the number of links is less than or equal to 4”, “none of the links is of the external type”, etc.

Step 106 increments the value of the counter L by unity, so that L gives the number of main resources associated with the dependent resource, and the method is taken to step 108.

Loop step 108 tests the value of the index i. If this index is less than N. then the method is taken to a step 110, else (i.e. if i is equal to N) the method moves on to a step 112.

Step 110 increments the value of the index i by unity and takes the method to step 102.

Step 112 tests the value of the counter L. If L is equal to 0, then the method is taken to a step 114. Else the method is taken to a subsequent step 116.

Exclusion step 114 withdraws the dependent resource from the indexing database and terminates the association method for the dependent resource under consideration.

Step 116 is likewise a step of testing the value of L. If L is greater than 1, then the method is taken to a step 118, else it is taken to a step 120.

Step 118 selects from amongst the main resources temporarily associated with the dependent resource, that main resource which minimizes a distance relative to the dependent resource. This distance is a decreasing function of the number of common folders between the URLs of the two resources. The method is then taken to step 120 if one main resource is selected. If a plurality of main resources minimize the distance, then the method is taken to step 114.

End-of-method step 120 validates the association between the dependent resource and the sole selected main resource.

It can clearly be seen that a search engine of the invention remedies the drawbacks of conventional search engines.

Intelligent indexing of main resources, adapted to take account of the context of a request launched by a user, enables them to be classified in major categories and makes it possible to perform high quality filtering of the responses to the request. In addition, this indexing is accompanied by associating a very large number of dependent resources to each of the main resources, thus making it possible to improve quantity while conserving the quality of the responses supplied.

Another advantage of this search engine is the possibility it provides of presenting a user with a resource that satisfies the criteria of the request, accompanied by a more general main resource explaining its context.

1/ A search engine comprising firstly an indexing module for indexing resources accessible on a computer network to create and update and indexing database, and secondly a search module for searching the network for resources and adapted to interrogate the indexing database on the basis of a request formulated by a user and to respond by supplying the URLs of resources corresponding to the request, the indexing module having means for collecting main resources, means for extracting dependent resources from the main resources, and means for indexing resources to extract descriptors therefrom, the search engine being characterized in that the indexing module further comprises association means for associating each dependent resource with no more than one main resource as a function of hypertext type links between the dependent resources and the main resource.

2/ A search engine according to claim 1, characterized in that the indexing module has means for transferring a copy of the descriptors of the main resources to the dependent resources associated therewith.

3/ A search engine according to claim 2, characterized in that the search module has means for filtering a resource indexed by the indexing module by combined processing of descriptors extracted from said resource and of descriptors transferred to said resource.

4/ A search engine according to any one of claims 1 to 3, characterized in that the search module is adapted to respond to a request by supplying the URL of a dependent resource corresponding to the request, associated with the hypertext link of the main resource associated with said dependent resource.

5/ A search engine according to any one of claims 1 to 4, characterized in that the association means include means for selecting not more than one main resource from a set of main resources that might be associated with a dependent resource by minimizing a distance computed between the dependent resource and each main resource.

6/ A search engine according to claim 5, characterized in that the distance between two resources is a decreasing function of the number of folders in common between the URLs of the two resources.

7/ A method of indexing resources accessible on a computer network so as to create and update an indexing database, the method comprising the following steps:
collecting main resources;
indexing the main resources; and
extracting dependent resources from the main resources;
the method being characterized in that it further comprises the following:
associating each dependent resource with not more than one main resource as a function of the hypertext links between these dependent resources and the main resource; and
transferring a copy of the descriptors of the main resources to the dependent resources that are associated therewith.

8/ An indexing method according to claim 7, characterized in that it further comprises a step of excluding from the indexing database any dependent resource that is not associated with a main resource.
